(19) United States
(12) Patent Application Publication
(10) Pub. No.: US 2024/0337408 A1
(43) Pub. Date: Oct. 10, 2024

(54) CONTROL SYSTEMS FOR CENTRALIZED APPLIANCE HUBS AND RELATED DEVICES AND METHODS

(71) Applicant: OVERCAST INNOVATIONS LLC, Seattle, WA (US)

(72) Inventors: Robert W. Andrade, JR., Seattle, WA (US); Jay Martin, Bainbridge Island, WA (US); James Rooney, Seattle, WA (US); Erik Hanson, Seattle, WA (US); Jon McClure, Tacoma, WA (US)

(21) Appl. No.: 18/627,300

(22) Filed: Apr. 4, 2024

Related U.S. Application Data
(60) Provisional application No. 63/494,440, filed on Apr. 5, 2023.

(51) Int. Cl. F24F 11/89; F24F 11/58; G05D 25/02; H04L 12/28

(52) U.S. Cl. CPC F24F 11/89; F24F 11/58; G05D 25/02; H04L 12/2827

(57) ABSTRACT

The present technology is generally directed to control systems for centralized appliance hubs and related devices, systems, and methods. In some embodiments, an appliance hub includes an onboard controller and one or more functional components. The onboard controller can be operably coupled to individual ones of the functional components, and can receive instructions for controlling individual ones of the functional components. In some embodiments, a plurality of the appliance hubs are mounted to a ceiling or otherwise arranged within an enclosure to form an appliance hub system. In some embodiments, the onboard controllers of multiple appliance hubs can be communicatively coupled to a system controller that can send instructions to the onboard controllers of one or more of the appliance hubs to individually control operation of the onboard lighting, HVAC, sensors, and/or other functional components carried by the appliance hubs.

### CROSS-REFERENCE TO RELATED APPLICATIONS

The present application claims priority to U.S. Provisional App. No. 63/494,440, filed Apr. 5, 2023, the entirety of which is incorporated by reference herein.

### TECHNICAL FIELD

The present technology generally relates to control systems for centralized appliance hubs and related devices and methods.

### BACKGROUND

As energy codes have become more stringent, the costs associated with controlling indoor climates have risen. Many traditional climate control systems, such as variable air volume (“VAV”) systems and constant air volume (“CAV”) systems, are now becoming cost-prohibitive due to high electricity usage associated with moving air and the rising costs of electricity. The costs associated with installing and maintaining climate control systems are also very high, as multi-person crews are often necessary to custom-fit wiring, ducting, piping, and other overhead in a given structure.

### BRIEF DESCRIPTION OF THE DRAWINGS

FIG. 1 is a perspective view of an appliance hub configured in accordance with embodiments of the present technology.

FIG. 2 is a wiring diagram of an appliance hub including an onboard controller operably coupled to one or more functional components, in accordance with embodiments of the present technology.

FIG. 3 is a perspective view of an appliance hub system configured in accordance with embodiments of the present technology.

FIG. 4 is a wiring diagram for an appliance hub system configured in accordance with embodiments of the present technology.

FIG. 5A-5C illustrate representative pages of an appliance hub control application configured in accordance with embodiments of the present technology.

FIGS. 6A-6C are perspective views of an appliance hub system configured in accordance with embodiments of the present technology.

### DETAILED DESCRIPTION

The present technology is generally directed to control systems for centralized appliance hubs and related devices, systems, and methods. In some embodiments, an appliance hub includes an onboard controller and one or more functional components, such as one or more lighting elements, sensors, climate control devices, fire suppression apparatuses, communication devices, acoustic controls, speakers, forced air vents, mechanical/electrical/plumbing (“MEP”) components, and/or other devices. The onboard controller can be operably coupled to individual ones of the functional components and can receive instructions for controlling individual ones of the functional components. In some embodiments, a plurality of the appliance hubs are mounted to a ceiling or otherwise arranged within an enclosure to form an appliance hub system. In some embodiments, the onboard controllers of multiple appliance hubs can be communicatively coupled to a system controller that can send instructions to the onboard controllers of one or more of the appliance hubs to individually control operation of the onboard lighting, HVAC, sensors, and/or other functional components carried by the appliance hubs. In these and/or other embodiments, one or more of the appliance hubs can be communicatively connected to a mobile device (e.g., a smart phone, tablet, computer) to send instructions and/or receive information from the onboard controller and/or the onboard devices (e.g., sensors, lights, HVAC). The centralized system controller and/or the connected mobile device can allow for individualized control over each device on each appliance hub. In some embodiments, the centralized system controller and/or devices connected thereto (e.g., a smart phone, tablet, computer) can provide data gathered from one or more of the appliance hubs and/or summaries thereof on a user interface for building owners, occupants, and/or others associated with control and/or management of the appliance hubs, and do so without requiring a building management system (“BMS”). In some embodiments, the system controller and/or the mobile device are separate from, but visible to, existing BMS systems.

In some embodiments, the onboard controller can communicate with the system controller and/or the mobile device to provide appliance hub-level lighting control and allow for application of various scenes suitable for specific uses and/or to enhance energy efficiency. For example, the lighting and HVAC systems of individual appliance hubs can turn on based on the detection of temperature, motion, occupancy, and/or other detected metrics. As another example, the onboard controller can turn on and/or off an air filtration unit based, at least in part, on air quality readings from an Indoor Air Quality sensor coupled to the appliance hub. The appliance hubs can also be individually controlled and/or grouped together for different applications, such as conference rooms versus personal working spaces. This smart hub system can provide energy savings, for example, by reducing or deactivating lighting, HVAC systems, etc. in a room when no occupants are detected.

In use, the appliance hubs of the present technology can arrive at a building (e.g., a building or floor under construction) with factory-installed controllers that are pre-wired and/or otherwise connected to all onboard devices (i.e., devices that are part of the appliance hub unit) to provide a seamless, plug and play platform. Increasing the controller density in a given appliance hub system by including an onboard controller on each appliance hub enables more IOT (“internet of things”) devices to be used in any given space. This, in turn, is expected to improve user experience by providing increased and/or more granular control over the devices provided on each appliance hub, which can lead to energy savings, improved air quality, more precise temperature control, etc. For example, lighting is typically controlled in large rooms in zones, with a zone near windows connected to a single daylight sensor that causes the zone to dim when there is enough light from the sun to offset lighting. However, with individual onboard control, the luminaires of each appliance hub can be dimmed or brightened based on feedback from sensors, leading to more granular control than the zone approach, but doing so in a cost-effective manner (e.g., in comparison to high-priced lighting units with their own smart controls). Further, the appliance hubs can be configured to operate with various pre-programmed lighting scenes that can be easily updated as the user's needs change. Additionally, the user can view data gathered from myriad IOT devices (temperature, IAQ sensors, occupancy, etc.) on a dashboard for owners/occupants to view without needing to login to a BMS system or even needing to have a BMS. This can create an independent data layer that is separate from the BMS.

Specific details of several embodiments of appliance hubs for use in enclosures, as well as associated systems and methods, are described below. As used herein, a “room” or “enclosure” can be enclosed or partially enclosed space, including spaces having full ceilings, partial ceilings, no ceilings, complete wall perimeters, partial-perimeter walls (e.g., one or more open sides), and/or other indoor or partially indoor spaces. Examples of enclosures include, but are not limited to, classrooms, offices, concert halls, foyers, cafeterias, restaurants, residential rooms, warehouses, and the like. The appliance hubs of the present technology, which can also sometimes be referred to as “clouds” or “acoustic clouds,” can be positioned in the upper portions of enclosures, such as suspended from or mounted to a ceiling. The appliance hubs can be installed such that they do not create plenum within the enclosure. In some embodiments, the space between the appliance hubs and/or between the appliance hubs and the ceiling can allow additional/increased amounts of light (e.g., sunlight from additional window height) to fill an enclosure than would otherwise be the case if the appliance hubs formed a plenum. In some applications, the appliance hubs can be mounted along or near a wall of an enclosure, in addition to or instead of having one or more appliance hubs mounted to the ceiling.

Appliance hubs of the present technology can be installed in original construction projects, or retrofitted to an existing structure or enclosure. The appliance hubs can include features to provide acoustic insulation within the enclosure and/or can include one or more device configured to regulate an environment within the enclosure and/or provide other functionality. Examples of these devices include one or more climate control apparatuses (e.g., diffusers, forced air ducts, chilled beams) configured to regulate a temperature within the enclosure, one or more lighting elements (e.g., downlights, uplights, etc.) configured to provide light within the enclosure, one or more fire suppression apparatuses (e.g., fire sprinklers) configured to suppress flames within the enclosure, a plurality of fluid lines configured to provide fluid service and return to one or both of the fire suppression apparatus and the climate control apparatus, and/or a plurality of electrical connections configured to provide electrical power and/or data to at least one of the climate control apparatus, the fire suppression apparatus, and the one or more lighting elements. As used herein, “fluid” refers to one or both of a liquid (e.g., water, refrigerant, etc.) and a gas (air, conditioned air, etc.). Preferably, the appliances include one or more of a sound level sensor, a motion sensor (e.g., an infrared sensor), a camera, a microphone, an air quality monitor, a carbon dioxide sensor, a carbon monoxide sensor, a smoke detector, a light level sensor, a heat sensor, a room temperature sensor, a dew point sensor, and/or a humidity sensor. Additional details regarding appliance hubs are described further below, and can be found the following U.S. patent applications which are incorporated by reference herein, in their entireties: U.S. Pat. No. 11,487,307, filed Jul. 1, 2019; U.S. patent application Ser. No. 17/956,713, filed Sep. 29, 2022; and U.S. patent application Ser. No. 18/452,456, filed Aug. 18, 2023.

As used herein, the use of relative terminology, such as “about,” “approximately,” “substantially” and the like refer to the stated value plus or minus ten percent. For example, the use of the term “about 100” refers to a range of from 90 to 110, inclusive. In instances in which the context requires otherwise and/or relative terminology is used in reference to something that does not include a numerical value, the terms are given their ordinary meaning to one skilled in the art.

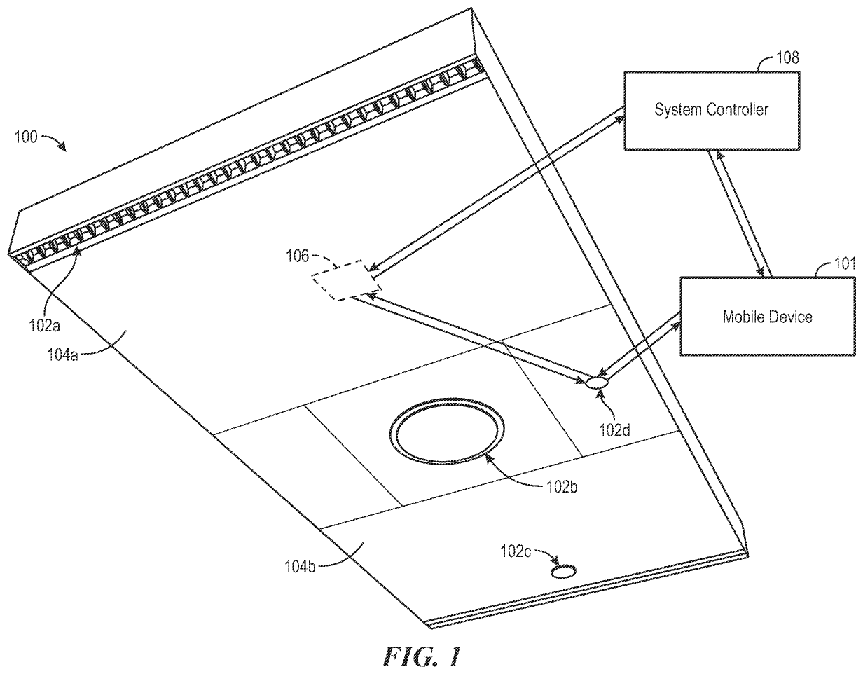

FIG. 1 is a perspective view of an appliance hub 100 (which can also be referred to as a “hub 100,” a “cloud 100,” an “acoustic cloud 100,” etc.) configured in accordance with embodiments of the present technology. The appliance hub 100 can include one or more functional components 102a-d. In the illustrated embodiments, the functional components 102a-d include one or more lighting elements 102a, one or more speakers 102b, one or more fire suppression apparatuses 102c, and one or more sensors 102d. The lighting elements 102a can include, for example, one or more light-emitting diodes (“LEDs”), incandescent sockets and bulbs, halogen sockets and bulbs, fluorescent sockets and bulbs, smart bulbs, uplights (e.g., oriented toward an upper portion of an enclosure), downlights (e.g., oriented toward a lower portion of an enclosure), linear lights, recessed lights, pendant fixture lights, low-profile lights, color-tunable lights, tunable white lights, circadian lighting, a combination thereof, and/or another type of lighting element. In some embodiments, the lighting elements are retractable (e.g., can hang downward as pendant lights and be retracted back toward appliance hub). In some embodiments, one or more of the lighting elements can include both direct and indirect lighting elements. The direct lighting elements can be oriented toward a floor of an enclosure, and the indirect lighting elements can be oriented toward a ceiling of the enclosure, e.g., to provide ambient light and/or reflect light off the ceiling toward the floor. The fire suppression apparatuses 102c can include, for example, fire sprinklers and/or other fire suppression apparatuses. The sensors 102d can include, for example, one or more light sensors (e.g., photocells, photo sensors, etc.), occupancy sensors, motion sensors, audio sensors, indoor air quality (“IAQ”) sensors, smoke detectors, air flow sensors, temperature sensors, fire alarms, multi-sensors, and/or other sensors. In these and/or other embodiments, the functional components 102a-d can include one or more climate control devices, fire suppression apparatuses, acoustic controls, forced air vents, mechanical/electrical/plumbing (“MEP”) components, and/or other devices. The climate control devices can include, for example, one or more HVAC devices, air conditioning devices, radiant heating units/panels, diffusers, variable refrigerant flow systems, chilled beams, and/or other climate controller devices. The communication devices can include, for example, wireless communication devices, Wi-Fi units, Bluetooth radios, cell DAS, speakers, microphones, displays, and/or other communication devices. In these and/or other embodiments, the appliance hub 100 can include one or more sound dampening components or panels 104a, 104b. The functionality of any two or more of the functional components may be combined into a single physical device, e.g., a multi-sensor can include two or more of the above-noted sensors. The arrangement, placement, and/or inclusion/exclusion of the functional components 102a-d onto the appliance hub 100 can be customized for the desired installation (e.g., classrooms, offices (private or open), conference rooms, etc.).

Individual ones of the functional components 102a-d can be operably coupled to an onboard controller 106 carried by the appliance hub 100. In some embodiments, the onboard controller 106 includes a Eclypse PTU 208 controller, manufactured by Distech Controls, headquartered in Brossard, Quebec, Canada, an enteliZONE Fan Coil Controller, manufactured by Delta™ Controls, headquartered in Surrey, BC, Canada, and/or other suitable controllers. The appliance hub 100 can include a universal DIN rail and/or bracket system configured to receive the onboard controller 106. In some embodiments, the onboard controller 106 includes a WiFi dongle and/or other suitable connectivity device that enables programming and/or reprogramming of the onboard controller 106 and/or other onboard devices from a remote device (e.g., a mobile device, a system controller) without the need for connection to an ethernet cable. The onboard controller 106 can be configured to provide a set number of inputs (e.g., at least 1, 2, 4, 6, 8, 10, 12, 14, 16, or more inputs) and/or outputs (e.g., at least 1, 2, 4, 6, 8, 10, 12, 14, 16, or more outputs), and the number of functional components 102a-d installed on the appliance hub 100 can be based, at least in part, on the number of inputs and/or outputs provided by the onboard controller 106. For example, the number of sensors installed on the appliance hub 100 can be based, at least in part, on the number of inputs provided by the onboard controller 106. The number of devices (e.g., fans, speakers, diffusers, lighting elements) controlled by the onboard controller 106 can be based, at least in part, on the number of outputs provided by the onboard controller 106.

The onboard controller 106 can be communicatively coupled to a system controller 108 (also referred to as a central controller, a room controller, a building controller, a wall-mounted interface, or the like) remote from the appliance hub 100 and configured to transmit commands to the onboard controller 106 to direct the operation of individual ones of the functional components 102a-d. The onboard controller 106 and the system controller 108 can communicate using a wired and/or wireless connection, via BACnet IP, BACnet MSTP, LonWorks, LonWorks IP, Modbus, IEEE 802.11, and/or another communication protocol. The onboard controller 106 and/or the system controller 108 can operate independently from and/or agnostic to any BMS present at an installation site. In some embodiments, the onboard controller 106 and/or the system controller 108 can communicate with the BMS, e.g., to allow the BMS receive information from and/or direct operation of the onboard controller 106 and/or the system controller 108. For example, the system controller 108 and/or the onboard controllers 106 can be operated separately from a BMS system, yet be visible to the BMS system. The system controller 108 can be positioned remotely from the appliance hub 100. For example, the system controller 108 can be in the same enclosure as the appliance hub 100 but spaced apart from the appliance hub 100, in a different enclosure, on a different floor of a same building, in a different building, outdoors, and/or other suitable places. The system controller 108 is not essential and can be omitted in at least some embodiments.

In some embodiments, one or both of the onboard controller 106 and/or the system controller 108 can be communicatively coupled to a mobile device 101 and/or one or more other computing devices. For example, a software application (“app”) running on the mobile device 101 can receive information from and/or transmit instructions to one or both of the onboard controller 106 and the system controller 108, e.g., to activate various lighting scenes, provide climate control settings, etc. The mobile device 101 can communicate with the onboard controller 106 and/or the system controller 108 via Wifi, Bluetooth, cellular, etc. In some embodiments, the mobile device 101 can eliminate the need for the system controller 108, e.g., so that the system controller 108 can be omitted. In these and/or other embodiments, the mobile device 101 can communicate with the onboard controller 106 directly, via the system controller 108, and/or via one or more of the functional components 102a-d of the appliance hub 100. In the illustrated embodiment, for example, the mobile device 101 communicates with the onboard controller 106 via a Bluetooth enabled multi-sensor 102d.

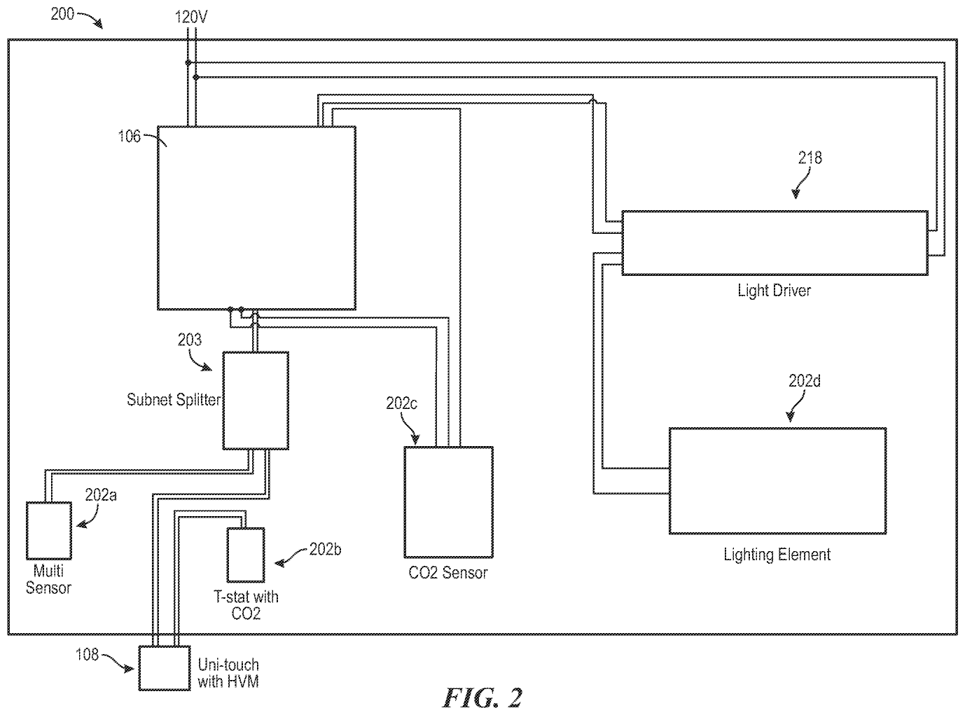

FIG. 2 is a wiring diagram of an appliance hub 200 including the onboard controller 106 operably coupled to one or more functional components 202a-d, in accordance with embodiments of the present technology. In the illustrated embodiment the functional components 202a-d include a multi-sensor 202a (including, e.g., a Bluetooth radio, a luminosity sensor, a motion sensor, and a temperature sensor), a thermostat 202b, a CO₂ sensor 202c (which can be mounted, e.g., inside a return air duct of the appliance hub 200), and a lighting element 202d. In these and/or other embodiments, the functional components 202a-d can include one or more additional and/or other functional components described herein. One of more of these components 202a-d can be connected to the onboard controller 106 directly, via a subnet splitter 203, and/or or using other suitable connection. The onboard controller 106 can be connected, via a wired connection (e.g., ethernet) and/or wirelessly to the system controller 108.

The onboard controller 106 can receive instructions (e.g., from the system controller 108 and/or the mobile device 101 of FIG. 1) that cause the functional components 202a-d of the appliance hub 200 to operate in one or more scenes or modes, such as one or more lighting scenes. For example, the lighting scenes can include: (i) a “Happy Hour” scene in which the lighting level provided by the lighting element 202d is lowered to change the ambiance or mood of the space; (ii) a “Bright” scene in which the lighting element 202d is operated at or near 100% luminance; (iii) a “MotionSense” scene in which the lighting element 202d operates based, at least in part, on data from the multi-sensor 202a, e.g., to dim to background level when no occupants or motion are detected (e.g., to increase or maximize energy savings) and increase luminance levels if occupants/motion is detected (e.g., beneath, proximate to, and/or approaching the appliance hub 200); (iv) a “LightSense” scene in which the luminance level provided by the lighting element 202d is controlled to meet a specific foot candle requirement and, based at least in part data from the multi-sensor 202a, the lighting element 202 is either brightened or dimmed to meet a specific foot candle requirement; and/or (v) an “OccupantControl” scene in which the user selects the lighting level provided by the lighting element 202d. These and/or other scenes can be preprogrammed on the onboard controller 106 and/or loaded on the onboard controller 106 from the system controller 108 and/or directly from the mobile device 101 (FIG. 1) and/or other connected devices, e.g., via Wifi, Bluetooth, ethernet, and/or other communication means.

In the illustrated embodiment, the lighting element 202d is operably coupled to the onboard controller 106 via a light driver 218 (also referred to as a “lighting driver”). In various embodiments, the hub 100 includes a plurality of lighting elements 202d and each lighting element 202d can be operably coupled to the onboard controller 106 via a corresponding light driver, or all or a subset of the lighting elements 202d can share a single light driver. All of the lighting elements 202d connected to the same light driver can be controlled together. For example, in some embodiments the hub 100 includes one or more direct lighting elements operably coupled to a first light driver and one or more indirect lighting elements operably coupled to a second light driver, thereby allowing the direct lighting elements to be controlled together as a single unit, separate from the indirect lighting elements, which are controlled together via the second driver. In these and/or other embodiments, lighting elements on multiple appliance hubs can share a single light driver. A person of ordinary skill in the art will appreciate that the number of lighting elements connected to a given light driver will alter the ways in which those lighting elements can be controlled or otherwise operated.

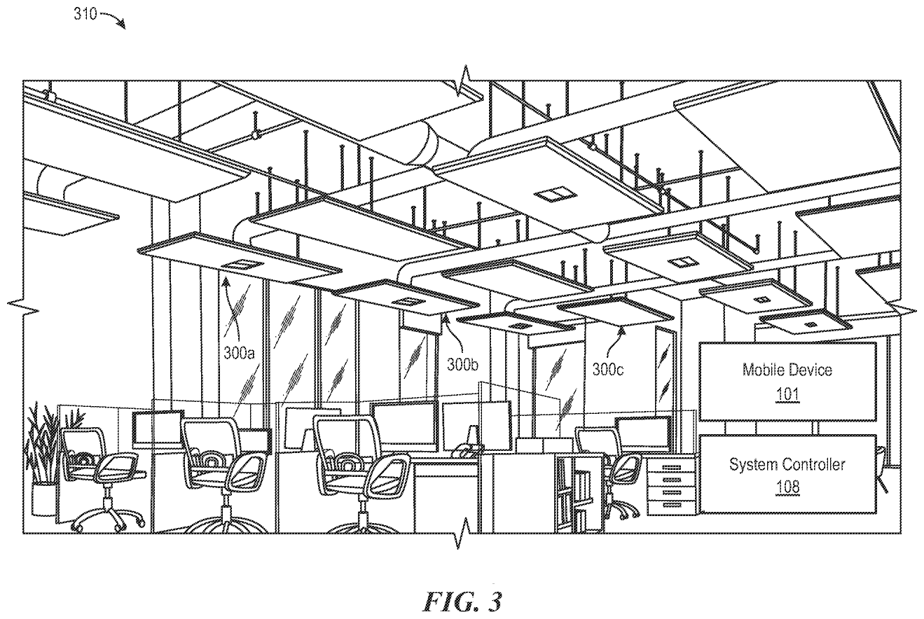

FIG. 3 is a perspective view of an appliance hub system 310 configured in accordance with embodiments of the present technology. The appliance hub system 310 includes a plurality of appliance hubs 300a-c suspended from an overhead structure and spaced apart from each other throughout an enclosed spaced (e.g., a room, atrium, building floor). Individual ones of the plurality of appliance hubs 300a-c can be at least generally similar or identical in structure and/or function to the appliance hub 100 of FIG. 1 and/or the appliance hub 200 of FIG. 2. Each of the plurality of appliance hubs 300a-c can be communicatively coupled to the system controller 108 and/or the mobile device 101. Each of the appliance hubs 300 can include an onboard controller (e.g., as described previously with reference to FIGS. 1 and 2) or multiple appliance hubs 300 (e.g., at least 2, 4, 6, 8, 10, 12, 14, 16, etc.) can share a single controller, e.g., the system controller 108 and/or an onboard controller carried by one of the multiple appliance hubs 300. The number of appliance hubs that share a single controller can vary based, at least in part, on the number of inputs and/or outputs provided by the single controller and/or the number and/or type of functional components carried by the appliance hubs 300. For example, if the system, controller 108 can output four signals, the system controller 108 can operate four appliance hubs with separately-controlled downlights, but only two appliance hubs that each include separately-controlled uplights and downlights (e.g., because each separately-controlled component uses one input). In some embodiments, a single controller can operate up to 16 different appliance hubs, e.g., depending on the configuration of the single controller, the functional elements including on each of the appliance hubs 300, and/or the control grouping of those functional elements. The operation of individual ones of the appliance hubs 300a-c can be adjusted based, at least in part, on one or more of the scenes described previously herein with reference to FIG. 2.

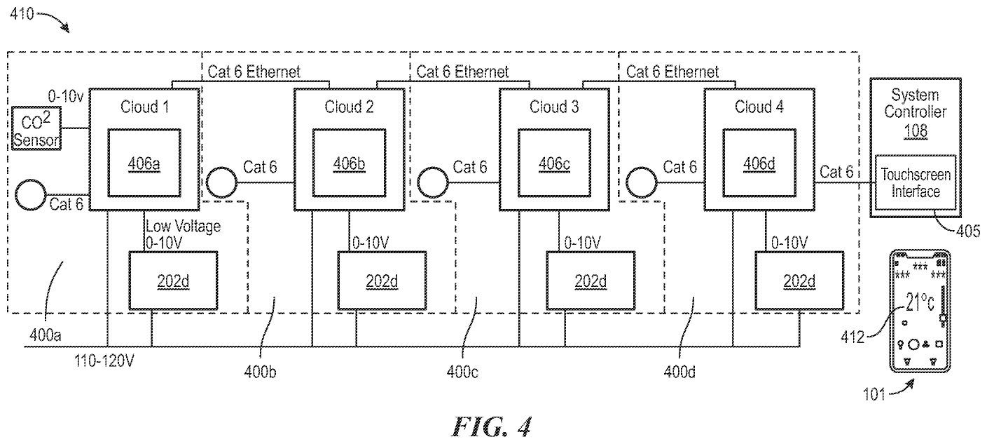

FIG. 4 is a wiring diagram for an appliance hub system 410 configured in accordance with embodiments of the present technology. The appliance hub system 410 can be at least generally similar or identical in structure and/or function to the appliance hub system 310 of FIG. 3. The appliance hub system 410 include a plurality of appliance hubs 400a-d, individual ones of which can be at least generally similar or identical in structure and/or function to the appliance hub 100 of FIG. 1, the appliance hub 200 of FIG. 2, and/or one or more of the appliance hubs 300a-c of FIG. 3. The functional components included on each of the appliance hubs 400a-d are representative of one embodiment; as described previously herein, one or more of the appliance hubs 400a-d can include additional and/or other function components in other embodiments.

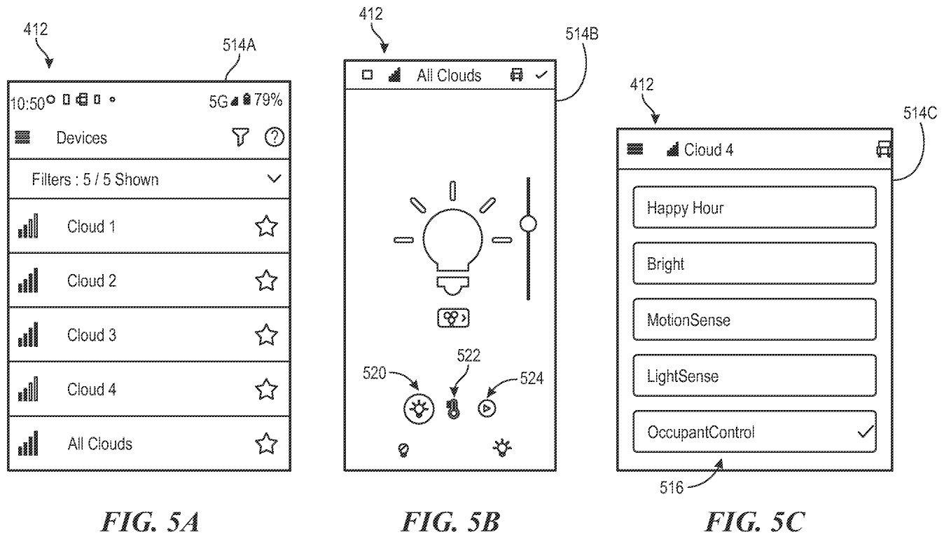

In some embodiments, the system controller 108 can be operably coupled to a user interface, such as a touchscreen display 405, a web-based dashboard, and/or another suitable user interface, to allow user to direct operation of the appliance hub system 410 and/or individual ones of the appliance hubs 400a-d. In at least some embodiments, for example, the system controller 108 includes an Allure UNITOUCH™ manufactured by Distech Controls, headquartered in Brossard, Quebec, Canada, and/or other suitable controllers As described previously with reference to FIG. 1, the mobile device 101 can run an app 412 that interfaces with the system controller 108 and/or directly with onboard controllers 406a-d of one or more of the appliance hubs 400a-d. Accordingly, in at least some embodiments, the system controller 108 can be omitted. As described in greater detail below with respect to FIGS. 5A-5C, the app 412 can allow a user to control operation of the appliance hub system 410, including by directing operation of individual appliance hubs 400a-d in the appliance hub system 410 and the functional components thereon.

FIG. 5A-5C illustrate representative pages 514a-c of the app 412 of FIG. 4. Specifically, FIG. 5A illustrates a main page 514a that displays the appliance hubs 400a-d in the appliance hub system 410 (FIG. 4). A user can select some or all of the appliance hubs 400a-d from the main page 514a and provide commands to the selected appliance hubs. In some instances, the user can select or “favorite” one or more of the clouds (using, e.g., the “star” icon shown in FIG. 5A) so that commands entered via the app 412 are provided to the favorite cloud(s) by default when the user is in proximity to more than one of the clouds. FIG. 5B illustrates an appliance hub control page 514b including controls for one of the appliance hubs 400a-d in the appliance hub system 410 (FIG. 4). The controls can include lighting controls 520, climate controls 522 (e.g., temperature, humidity, etc.), scene selection controls 524, etc. FIG. 5C illustrates a scene selection page 514c including a plurality of scenes 516 that the user can select to control operation of the appliance hubs 400a-d in the appliance hub system 410 (FIG. 4). In the illustrated embodiment, the scene selection page 514c includes the “Happy Hour,” “Bright,” “MotionSense,” “LightSense,” and “OccupantControl,” scenes described previously with reference to FIG. 2. In these and/or other embodiments, the scene selection page 514c can include more, fewer, and/or other scenes. In some embodiments, the app 412 further includes a dashboard page to display data gathered from one or more devices carried by the appliance hubs 400a-d (e.g., temperature sensor data, IAQ sensor data, occupancy sensor data, etc.).

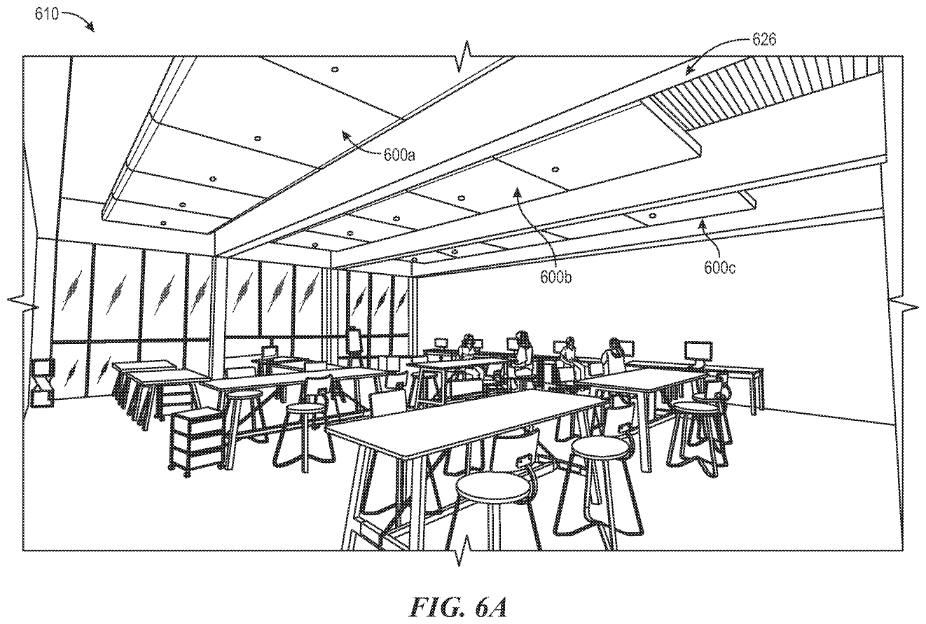

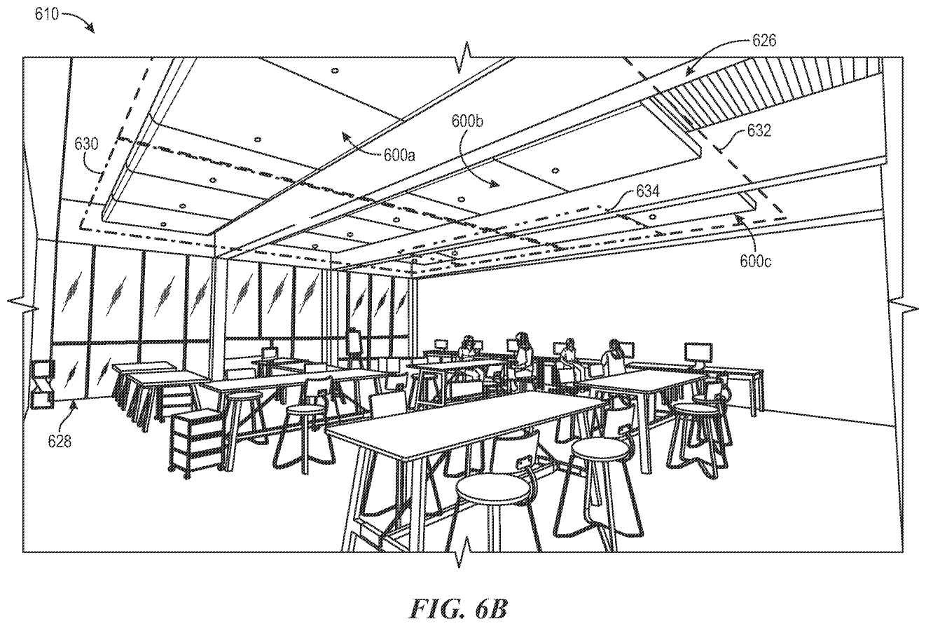

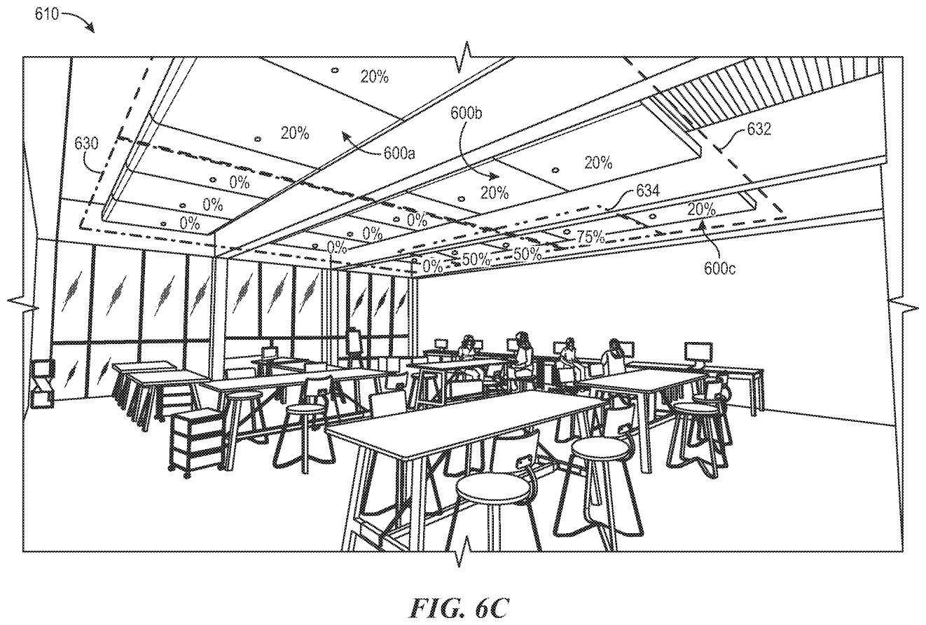

FIGS. 6A-6C are perspective views of an appliance hub system 610 configured in accordance with embodiments of the present technology. Referring to FIG. 6A, the appliance hub system 610 can include a plurality of appliance hubs 600 (for illustrative clarity, only first, second, and third appliance hubs 600a-c are labeled in FIG. 6A) arranged in one or more rows and/or columns within an enclosure 626. In the illustrated embodiments, for example, the appliance hub system 610 includes three rows and each row includes five appliance hubs 600 (e.g., three rows and five columns). In other embodiments, the appliance hub system 610 include up to two, four, five, six, or more rows and up to two, three, four, six, or more columns. Each of the appliance hubs 600 can include an onboard controller (e.g., the onboard controller 106 of FIGS. 1 and 2) and a multi-sensor (e.g., the multi-sensor 202a of FIG. 2), and can be configured to communicate with a system controller (e.g., the system controller 108 of FIG. 1).

In some embodiments, aspects of the appliance hub system 610 can be automated. For example, referring to FIG. 6B, the onboard controller for each of the appliance hubs 600 can use data obtained via the multi-sensor to adjust the illumination level provided by each of the appliance hubs 600, and/or change other ambient conditions (e.g., temperature, speaker volume, etc.) within the enclosure 626. As shown in FIG. 6B, the enclosure 626 includes areas that are unoccupied (e.g., unoccupied area 632), occupied (e.g., occupied area 634), and receiving daylight from one or more windows 628 (e.g., a daylit area 630 of the enclosure 626). The onboard controllers for the appliance hubs 600 can determine that the associated appliance hub 600 is in the occupied area 634 or the unoccupied area 632, respectively, based on motion data obtained via the multi-sensor. The onboard controllers for the appliance hubs 600 can determine that the associated appliance hub is in the daylit area based on luminosity data obtained via the multi-sensor. The daylit area can be associated with one or more predetermined luminosity data values (e.g., luminosity data equal to or exceeding at least 5000 lumens, 6000 lumens, 7000 lumens, 8000 lumens, 9000 lumens, or 10000 lumens) and/or can be detected continuously or periodically based at least in part on geographic location (e.g., latitude, longitude, elevation), ambient conditions (e.g., weather patterns), the time of day, and/or other factors affecting ambient light levels.

Referring to FIG. 6C, based on the data obtained by the multi-sensors, each of the onboard controllers can adjust the operation of the associated appliance hub 600 In the illustrated embodiment, for example, the onboard controllers for the appliance hubs 600 in the daylit area deactivate lighting elements (e.g., set to 0% of max illumination) on the appliance hubs 600 in the daylit area 630 and the onboard controllers for the appliance hubs 600 in the unoccupied area 632 set lighting elements on the appliance hubs 600 in the unoccupied area to a low illumination level (e.g., up to 20% of max illumination, such as about 25% of max illumination). Because there are no people in the unoccupied area 632, setting the lighting elements on the appliance hubs in the unoccupied area 632 to the low illumination level can reduce the overall power consumption without, or substantially without, impairing these people's ability to use the enclosure 626 in a comfortable and safe manner. The onboard controllers for the appliance hubs 600 in the occupied area 634 can activate lighting elements on the appliance hubs 600 in the occupied area 634. As shown in FIG. 6C, some of the appliance hubs in the occupied area 634 are also in the daylit area 630. Accordingly, the onboard controllers for the appliance hubs 600 in both the occupied area 634 and the daylit area 630 can set the lighting elements on these appliance hubs 600 to a medium illumination level (e.g., between 30% and 60% of max illumination, such as about 50% of max illumination), while the onboard controller for the appliance hub in the occupied area 634 but outside of the daylit area 630 can set the lighting elements on these appliance hubs 600 to a high illumination level (e.g., between about 60% and 100% of max illumination, such as about 75%). In some embodiments, the difference in the illumination levels provided by the lighting elements in the occupied area 634 and the daylit area 630 and the lighting elements in the occupied area 634 but outside the daylit area 630 can be based at least in part on the amount of natural light detected in the daylit area 630 so that, e.g., a total illumination level in occupied area 634 (including both natural light and light from the appliance hubs 600) is uniform or at least generally uniform through the occupied area 634.

Although FIGS. 6A-6C are described with reference to natural light and illumination levels, in these and/or other embodiments the onboard controllers can on each of the appliance hubs 600 can adjust other aspects of the appliance hubs 600 such as the level of heating or cooling provided by one or more of the appliance hubs 600 based at least in part on a temperature threshold (e.g., set by user), air filtration units based at least in part on air quality thresholds, a volume of music or other sound provided by one or more of the appliance hubs 600, and/or the operation of any of the other devices described herein. Additionally, or alternatively, the appliance hubs 600 may communicate the data obtained from the multi-sensors to the system controller 108 (FIG. 1) and/or the mobile device 101 (FIG. 1) so that those devices can direct operation of one or more of the appliance hubs 600 based, at least in part, on the obtained data, in addition to or instead of these processes operating natively on the onboard controllers of the individual appliance hubs 600.

### Examples

Several aspects of the present technology are described with reference to the following examples.

1. An appliance hub system, comprising:
an appliance hub configured to be positioned in an upper portion of an enclosure, the appliance hub comprising—
   an onboard controller,
   a sensor in communication with the onboard controller, the sensor configured to obtain sensor data associated with a region of the enclosure; and
   a device operably coupled to the onboard controller; and
a system controller configured to be in communication with the appliance hub and configured to—
   receive the sensor data from the sensor of the appliance hub; and
   transmit instructions to the onboard controller for operating the device, wherein the instructions are based at least in part on the sensor data.

2. The appliance hub system of example 1 wherein—
the appliance hub is one of a plurality of appliance hubs and each of the plurality of appliance hubs comprises—
   an onboard controller,
   a sensor in communication with to the onboard controller, wherein the sensor is configured to obtain sensor data associated with the region of the enclosure; and
   a device operably coupled to the onboard controller; and
the system controller is in communication with each of the plurality of appliance hubs and configured to—
   receive sensor data from the sensor of each of the plurality of appliance hubs; and
   transmit, via the onboard controller of each of the plurality of appliance hubs, instructions to the device of each of the plurality of appliance hubs,
   wherein, for a given one of the plurality of appliance hubs, the instructions sent to the device of the given appliance hub are based on the sensor data received from the given appliance hub.

3. The appliance hub system of example 1 or 2 wherein—
the device comprises a lighting element,
the sensor data comprises luminosity data associated with the region, and
the instructions cause the lighting element to provide an amount of light based at least in part on the luminosity data associated with the region.

4. The appliance hub system of example 3 wherein the sensor data further comprises room occupancy data, and wherein the instructions cause the lighting element to provide an amount of light based at least in part on the luminosity data and the room occupancy data.

5. The appliance hub system of any of examples 1-4 wherein the appliance hub is a first appliance hub having a first onboard controller, a first sensor configured to obtain first sensor data associated with a first region of the enclosure, and a first lighting element configured to receive first instructions; and wherein the appliance hub system further comprises a second appliance hub configured to be positioned in the upper portion of the enclosure, the second appliance hub including—
a second onboard controller,
a second sensor in communication with the second onboard controller, wherein the second sensor is configured to obtain second sensor data associated with a second region of the enclosure; and
a second lighting element operably coupled to the second onboard controller;
wherein the system controller is in communication with the second appliance hub and is configured to—
   receive the second sensor data from the second appliance hub; and
   transmit second instructions to the second onboard controller for operating the second lighting element, wherein the second instructions are based at least in part on the second sensor data.

6. The appliance hub system of example 5 wherein—
the first and second sensor data indicate that the first region has a first luminosity and the second region has a second luminosity different than the first luminosity, and
the first instructions cause the first lighting element to adjust the first luminosity to equal the second luminosity.

7. The appliance hub system of example 5 wherein—
the first sensor data indicates that a person is present in the first region,
the second sensor data indicates that no people are present in the second region,
the first instructions increase a first amount of light provided by the first lighting element, and
the second instructions decrease a second amount of light provided by the second lighting element.

8. The appliance hub system of any of examples 5-7 wherein the second instructions are different than the first instructions.

9. The appliance hub system of any of examples 1-8 wherein the system controller is configured to receive the instructions from a mobile device.

10. The appliance hub system of any of examples 1-9 wherein the system controller is configured to receive the instructions from a building management system.

11. A method of controlling an appliance hub system, the method comprising:
at a system controller in communication with a plurality of appliance hubs, each of the plurality of appliance hubs comprising (i) an onboard controller, (ii) a sensor in communication with the onboard controller and configured to obtain sensor data associated with a respective region of an enclosure, and (iii) a device operably coupled to the onboard controller—
   receiving sensor data from the plurality of appliance hubs, wherein the sensor data received from individual ones of the plurality of appliance hubs is associated with the respective region; and
   transmitting, to the onboard controller of each of the plurality of appliance hubs, instructions for operating the device on each of the plurality of appliance hubs, wherein, for each of the plurality of appliance hubs, the transmitted instructions are based at least in part on the sensor data received from the appliance hub to which the instructions are transmitted.

12. The method of example 11 wherein—
the plurality of appliance hubs comprise a first appliance hub and a second appliance;
receiving sensor data comprises receiving (i) first sensor data associated with a first region of the enclosure from the first appliance hub and (ii) second sensor data from the second appliance hub and associated with a second region of the enclosure different than the first region, the second sensor data different than the first sensor data; and
transmitting instructions comprises transmitting (i) first instructions to the first appliance hub and (ii) second instructions, different than the first instructions, to the second appliance hub.

13. The method of example 11 or 12 wherein—
the plurality of appliance hubs comprise an appliance hub configured to obtain sensor data associated with a first region of the enclosure;
the obtained sensor data indicates that the first region has a first luminosity different than a second luminosity in a second region of the enclosure; and
transmitting instructions comprises transmitting instructions to cause a lighting element of the appliance hub to adjust the first luminosity so that the first luminosity is equal to the second luminosity.

14. The method of any of examples 11-13 wherein—
the plurality of appliance hubs comprise an appliance hub configured to obtain sensor data associated with a first region of the enclosure;
the obtained sensor data indicates that the first region has a first luminosity less than a second luminosity in a second region of the enclosure; and
transmitting instructions comprises transmitting instructions to cause a lighting element of the appliance hub to increase the first luminosity so that the first luminosity is equal to the second luminosity.

15. The method of any of examples 11-14 wherein transmitting instructions comprises transmitting different instructions to different ones of the plurality of appliance hubs based at least in part on different sensor data received from the different ones of the plurality of appliance hubs.

16. The method of any of examples 11-15 wherein the sensor comprises a luminosity sensor and the device comprises a lighting element, and wherein, for each of the plurality of appliance hubs—
receiving sensor data comprises receiving luminosity data, and
transmitting instructions comprises transmitting instructions to the lighting element based at least in part on the luminosity data.

17. The method of example 16 wherein, for each of the plurality of appliance hubs—
receiving sensor data further comprises receiving enclosure occupancy data, and
transmitting instructions comprises transmitting instructions to the lighting element based at least in part on the luminosity data and the enclosure occupancy data.

18. The method of example 17 wherein the sensor data indicates that a first region of the enclosure is occupied by one or more individuals and that a second region of the enclosure is unoccupied, and wherein transmitting instructions comprises—
transmitting first instructions to a first subset of the plurality of appliance hubs that are positioned within the first region to cause first lighting elements carried by the first subset of the plurality of appliance hubs to increase a first amount of light provided to the first region; and
transmitting second instructions to a second subset of the plurality of appliance hubs that are positioned within the second region to cause second lighting elements carried by the second subset of the plurality of appliance hubs to decrease a second amount of light provided to the second region.

19. The method of any of examples 11-18, further comprising, at the system controller, receiving the instructions from a building management system.

20. The method of any of examples 11-19, further comprising, at the system controller, receiving the instructions from a mobile device.

### CONCLUSION

In some embodiments, specific naming conventions can be established and associated with specific appliance hubs and components thereof. Use of specific/preset names or identifiers for the appliance hubs and components can allow for reliable and accurate tracking of the appliance hubs and components. Using consistent names/identifiers for like parts can also reduce complications during installation, repair, refurbishment, customization, replacement, and other operations conduct with or on the appliance hubs. Consistent naming/identifying of appliance hubs and components thereof can also improve machine learning associated with data detection and recordation from the appliance hubs and components thereof by improving the accuracy of assessments that can be made during analysis of the collected data (e.g., reliable attribution of location and type features of the data—such as temperature data from a specific room or location within a room).

It may be desirable for manufacturing, marketing, inventory, and other purposes to have preset appliance hub “models,” wherein each model has a preset combination of components. The present combination of components for a given model can be configured for certain settings (e.g., classrooms, offices, hallways, conference rooms, cafeterias, warehouses, etc.). For example, a base model might include a hanging kit (e.g., hangers, fasteners, etc.) configured to facilitate physical installation of the appliance hub. The base model may include a substrate, lighting elements, unique identifier(s) (e.g., QR code tag(s), Bluetooth® beacon(s), etc.), an acoustic material, and a light sensor. In some embodiments, an “A” model may include, in addition to one or all of the base model features, a chilled beam, fluid hoses, fire/smoke alarm speaker and/or strobes, an AV speaker, and/or a Wi-Fi access point and/or router. A “B” model may include, in addition to one or all of the features of the base model, an AV speaker, a fire/smoke alarm speaker and/or strobe, and/or a Wi-Fi access point and/or router.

In some embodiments, combining multiple components and associated functions (e.g., lights, sensors, climate control modules, sprinklers, speakers, etc.) into a single appliance hub can streamline permitting for new construction or retrofitting. For example, a single permit authority may be tasked with evaluating the appliance hub installations, rather than multiple permit authorities tasked with permitting the multiple different components.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. Moreover, the various embodiments described herein may also be combined to provide further embodiments. Reference herein to “one embodiment,” “an embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment.

To the extent any materials incorporated herein by reference conflict with the present disclosure, the present disclosure controls.

Certain aspects of the present technology, including operation of one or more components of the appliance hubs described previously herein, may take the form of computer-executable instructions, including routines executed by a controller or other data processor. In some embodiments, a controller or other data processor is specifically programmed, configured, and/or constructed to perform one or more of these computer-executable instructions. Furthermore, some aspects of the present technology may take the form of data (e.g., non-transitory data) stored or distributed on computer-readable media, including magnetic or optically readable and/or removable computer discs as well as media distributed electronically over networks. Accordingly, data structures and transmissions of data particular to aspects of the present technology are encompassed within the scope of the present technology. The present technology also encompasses methods of both programming computer-readable media to perform particular steps and executing the steps.

Unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Where the context permits, singular or plural terms may also include the plural or singular term, respectively. Additionally, the term “comprising” is used throughout to mean including at least the recited feature(s) such that any greater number of the same feature and/or additional types of other features are not precluded. Directional terms, such as “upper,” “lower,” “front,” “back,” “vertical,” and “horizontal,” may be used herein to express and clarify the relationship between various elements. It should be understood that such terms do not denote absolute orientation. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. An appliance hub system, comprising:
an appliance hub configured to be positioned in an upper portion of an enclosure, the appliance hub comprising—
an onboard controller,
a sensor in communication with the onboard controller, the sensor configured to obtain sensor data associated with a region of the enclosure; and
a device operably coupled to the onboard controller; and
a system controller configured to be in communication with the appliance hub and configured to—
receive the sensor data from the sensor of the appliance hub; and
transmit instructions to the onboard controller for operating the device, wherein the instructions are based at least in part on the sensor data.

2. The appliance hub system of claim 1 wherein—
the appliance hub is one of a plurality of appliance hubs and each of the plurality of appliance hubs comprises—
an onboard controller,
a sensor in communication with to the onboard controller, wherein the sensor is configured to obtain sensor data associated with the region of the enclosure; and
a device operably coupled to the onboard controller; and
the system controller is in communication with each of the plurality of appliance hubs and configured to—
receive sensor data from the sensor of each of the plurality of appliance hubs; and
transmit, via the onboard controller of each of the plurality of appliance hubs, instructions to the device of each of the plurality of appliance hubs,
wherein, for a given one of the plurality of appliance hubs, the instructions sent to the device of the given appliance hub are based on the sensor data received from the given appliance hub.

3. The appliance hub system of claim 1 wherein—
the device comprises a lighting element,
the sensor data comprises luminosity data associated with the region, and
the instructions cause the lighting element to provide an amount of light based at least in part on the luminosity data associated with the region.

4. The appliance hub system of claim 3 wherein the sensor data further comprises room occupancy data, and wherein the instructions cause the lighting element to provide an amount of light based at least in part on the luminosity data and the room occupancy data.

5. The appliance hub system of claim 1 wherein the appliance hub is a first appliance hub having a first onboard controller, a first sensor configured to obtain first sensor data associated with a first region of the enclosure, and a first lighting element configured to receive first instructions; and wherein the appliance hub system further comprises a second appliance hub configured to be positioned in the upper portion of the enclosure, the second appliance hub including—
a second onboard controller,
a second sensor in communication with the second onboard controller, wherein the second sensor is configured to obtain second sensor data associated with a second region of the enclosure; and
a second lighting element operably coupled to the second onboard controller;
wherein the system controller is in communication with the second appliance hub and is configured to—
receive the second sensor data from the second appliance hub; and
transmit second instructions to the second onboard controller for operating the second lighting element, wherein the second instructions are based at least in part on the second sensor data.

6. The appliance hub system of claim 5 wherein—
the first and second sensor data indicate that the first region has a first luminosity and the second region has a second luminosity different than the first luminosity, and
the first instructions cause the first lighting element to adjust the first luminosity to equal the second luminosity.

7. The appliance hub system of claim 5 wherein—
the first sensor data indicates that a person is present in the first region,
the second sensor data indicates that no people are present in the second region,
the first instructions increase a first amount of light provided by the first lighting element, and
the second instructions decrease a second amount of light provided by the second lighting element.

8. The appliance hub system of claim 5 wherein the second instructions are different than the first instructions.

9. The appliance hub system of claim 1 wherein the system controller is configured to receive the instructions from a mobile device.

10. The appliance hub system of claim 1 wherein the system controller is configured to receive the instructions from a building management system.

11. A method of controlling an appliance hub system, the method comprising:
at a system controller in communication with a plurality of appliance hubs, each of the plurality of appliance hubs comprising (i) an onboard controller, (ii) a sensor in communication with the onboard controller and configured to obtain sensor data associated with a respective region of an enclosure, and (iii) a device operably coupled to the onboard controller—
receiving sensor data from the plurality of appliance hubs, wherein the sensor data received from individual ones of the plurality of appliance hubs is associated with the respective region; and
transmitting, to the onboard controller of each of the plurality of appliance hubs, instructions for operating the device on each of the plurality of appliance hubs, wherein, for each of the plurality of appliance hubs, the transmitted instructions are based at least in part on the sensor data received from the appliance hub to which the instructions are transmitted.

12. The method of claim 11 wherein—
the plurality of appliance hubs comprise a first appliance hub and a second appliance;
receiving sensor data comprises receiving (i) first sensor data associated with a first region of the enclosure from the first appliance hub and (ii) second sensor data from the second appliance hub and associated with a second region of the enclosure different than the first region, the second sensor data different than the first sensor data; and
transmitting instructions comprises transmitting (i) first instructions to the first appliance hub and (ii) second instructions, different than the first instructions, to the second appliance hub.

13. The method of claim 11 wherein—
the plurality of appliance hubs comprise an appliance hub configured to obtain sensor data associated with a first region of the enclosure;
the obtained sensor data indicates that the first region has a first luminosity different than a second luminosity in a second region of the enclosure; and
transmitting instructions comprises transmitting instructions to cause a lighting element of the appliance hub to adjust the first luminosity so that the first luminosity is equal to the second luminosity.

14. The method of claim 11 wherein—
the plurality of appliance hubs comprise an appliance hub configured to obtain sensor data associated with a first region of the enclosure;
the obtained sensor data indicates that the first region has a first luminosity less than a second luminosity in a second region of the enclosure; and
transmitting instructions comprises transmitting instructions to cause a lighting element of the appliance hub to increase the first luminosity so that the first luminosity is equal to the second luminosity.

15. The method of claim 11 wherein transmitting instructions comprises transmitting different instructions to different ones of the plurality of appliance hubs based at least in part on different sensor data received from the different ones of the plurality of appliance hubs.

16. The method of claim 11 wherein the sensor comprises a luminosity sensor and the device comprises a lighting element, and wherein, for each of the plurality of appliance hubs—
receiving sensor data comprises receiving luminosity data, and
transmitting instructions comprises transmitting instructions to the lighting element based at least in part on the luminosity data.

17. The method of claim 16 wherein, for each of the plurality of appliance hubs—
receiving sensor data further comprises receiving enclosure occupancy data, and
transmitting instructions comprises transmitting instructions to the lighting element based at least in part on the luminosity data and the enclosure occupancy data.

18. The method of claim 17 wherein the sensor data indicates that a first region of the enclosure is occupied by one or more individuals and that a second region of the enclosure is unoccupied, and wherein transmitting instructions comprises—
transmitting first instructions to a first subset of the plurality of appliance hubs that are positioned within the first region to cause first lighting elements carried by the first subset of the plurality of appliance hubs to increase a first amount of light provided to the first region; and
transmitting second instructions to a second subset of the plurality of appliance hubs that are positioned within the second region to cause second lighting elements carried by the second subset of the plurality of appliance hubs to decrease a second amount of light provided to the second region.

19. The method of claim 11, further comprising, at the system controller, receiving the instructions from a building management system.

20. The method of claim 11, further comprising, at the system controller, receiving the instructions from a mobile device.
